(19) United States
(12) Patent Application Publication
(10) Pub. No.: US 2007/0217714 A1
(43) Pub. Date: Sep. 20, 2007

(54) IMAGE PROCESSING APPARATUS AND IMAGE PROCESSING METHOD

(75) Inventors: Yasuyuki SATO, Tokyo (JP); Takaaki Fuchie, Kanagawa (JP); Mototsugu Takamura, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/682,965

(22) Filed: Mar. 7, 2007

(30) Foreign Application Priority Data
Mar. 17, 2006 (JP) 2006-074712

(51) Int. Cl. G06K 9/32

(52) U.S. Cl. 382/300

(57) ABSTRACT

An image processing apparatus for interpolating a pixel value of an interpolation pixel which makes an object of an interpolation process, includes a production section configured to produce, based on the position of the interpolation pixel, a pixel value group including the pixel value of the interpolation pixel and a plurality of pixel values of different pixels; a write control section configured to control a plurality of storage sections; a readout control section configured to control the storage sections so that the pixel values of the pixels included in the pixel value group are read out at a time from the storage sections in which the pixel values of the pixels included in the pixel value group are stored; and an interpolation section configured to interpolate the pixel value of the interpolation pixel using the pixel value group read out by the readout control section.

### CROSS REFERENCES TO RELATED APPLICATIONS

The present invention contains subject matter related to Japanese Patent Application JP 2006-074712 filed with the Japanese Patent Office on Mar. 17, 2006, the entire contents of which being incorporated herein by reference.

### BACKGROUND OF THE INVENTION

1. Field of the Invention

This invention relates to an image processing apparatus and an image processing method.

2. Description of the Related Art

In related art, in an LSI (Large Scale Integration) which performs an interpolation process, image data before an interpolation process which are formed from a plurality of pixel values of different pixels are stored into a memory (IC (Integrated Circuit)) for exclusive use provided externally.

Some memories provided externally of an LSI operate at a speed as high as several times that of a memory built in an LSI. However, it is difficult to use a single LSI to assure a bandwidth which may be required for an interpolation process of a high degree of accuracy which uses many pixel values before an interpolation process. Further, where a memory operates at a high speed, it exhibits high power consumption.

Therefore, it has been considered to provide a plurality of memories externally of an LSI and connect the memories in parallel to the LSI in order to assure a bandwidth necessary for an interpolation process of a high degree of accuracy.

In this instance, however, for the connection between the memories and the LSI, such a very great number of wiring lines that the connection of them is difficult are used. Further, since a great number of parts are used and a wiring line region is increased when compared with those where a single memory is connected, the scale of the circuitry formed from the memories and the LSI increases as much.

On the other hand, also another LSI has been proposed which includes a built-in memory of a large storage capacity which is connected to a processing circuit by wiring lines which allow transmission of multiple bits so that a high frequency bandwidth is assured with a low operating frequency. Also an LSI which includes a plurality of built-in memories of a low storage capacity has been proposed and is disclosed, for example, in Japanese Patent Laid-Open No. 2000-11190.

### SUMMARY OF THE INVENTION

However, since the memories can be accessed at one address at a time, even if a high bandwidth is assured, where pixel values before interpolation to be used for an interpolation process are stored in different addresses of the same memory, all of the pixel values to be used for the interpolation process may not be read out simultaneously. Therefore, it is difficult to perform interpolation of a high degree of accuracy while suppressing increase of the power consumption.

Accordingly, it is desirable to provide an image processing apparatus and an image processing method which can perform interpolation of a high degree of accuracy while suppressing increase of the power consumption.

According to an embodiment of the present invention, there is provided an image processing apparatus for interpolating a pixel value of an interpolation pixel which makes an object of an interpolation process, including a production section configured to produce, based on the position of the interpolation pixel, a pixel value group including the pixel value of the interpolation pixel and a plurality of pixel values of different pixels to be used for the interpolation process, a write control section configured to control a plurality of storage sections for storing pixel values so that the pixel values of the pixels included in the pixel value group produced by the production section are written into different ones of the storage sections, a readout control section configured to control the storage sections so that the pixel values of the pixels included in the pixel value group are read out at a time from the storage sections in which the pixel values of the pixels included in the pixel value group are stored, and an interpolation section configured to interpolate the pixel value of the interpolation pixel using the pixel value group read out by the readout control section.

The image processing apparatus may further include a rearrangement section configured to rearrange the pixel values of the pixel value group read out by the read control section so as to be in an order corresponding to the interpolation process of the interpolation section, the interpolation section performing the interpolation process for the pixel value of the interpolation pixel using the pixel value group rearranged by the rearrangement section.

According to another embodiment of the present invention, there is provided an image processing method for interpolating a pixel value of an interpolation pixel which makes an object of an interpolation process, including the steps of producing, based on the position of the interpolation pixel, a pixel value group including the pixel value of the interpolation pixel and a plurality of pixel values of different pixels to be used for the interpolation process, controlling a plurality of storage sections for storing pixel values so that the pixel values of the pixels included in the pixel value group produced by the production step are written into different ones of the storage sections, controlling the storage sections so that the pixel values of the pixels included in the pixel value group are read out at a time from the storage sections in which the pixel values of the pixels included in the pixel value group are stored, and interpolating the pixel value of the interpolation pixel using the pixel value group read out by the readout control step.

In the image processing apparatus and the image processing method, based on the position of an interpolation pixel, a pixel value group including the pixel value of the interpolation pixel and a plurality of pixel values of different pixels to be used for the interpolation process is produced. Then, a plurality of storage sections for storing pixel values are controlled so that the pixel values of the pixels included in the pixel value group produced as above are written into different ones of the storage sections. Thereafter, the storage sections are controlled so that the pixel values of the pixels included in the pixel value group are read out at a time from the storage sections in which the pixel values of the pixels included in the pixel value group are stored. Further, the pixel value of the interpolation pixel is interpolated using the pixel value group read out as above.

With the image processing apparatus and the image processing method, interpolation can be performed with a high degree of accuracy while increase of the power consumption is suppressed.

### BRIEF DESCRIPTION OF THE DRAWINGS

FIG. 1 is a block diagram showing an example of a configuration of an image processing system to which the present invention is applied;

FIG. 2 is a block diagram showing an example of a detailed configuration of a RAM module shown in FIG. 1;

FIGS. 3 and 4 are a block diagram and a diagrammatic view, respectively, illustrating details of flows of pixel values before and after an interpolation operation;

FIGS. 5 and 6 are views illustrating write addresses;

FIG. 7 is a diagrammatic view illustrating a read address;

FIG. 8 is a view illustrating a pixel group;

FIG. 9 is a flow chart illustrating an image transform process;

FIG. 10 is a flow chart illustrating a writing process;

FIG. 11 is a flow chart illustrating a reading out process;

FIG. 12 is a block diagram showing an example of an image processing apparatus in which a DME shown in FIG. 1 is incorporated; and

FIG. 13 is a block diagram showing an example of a recording and reproduction apparatus in which the DME is incorporated.

### DETAILED DESCRIPTION OF THE PREFERRED EMBODIMENT

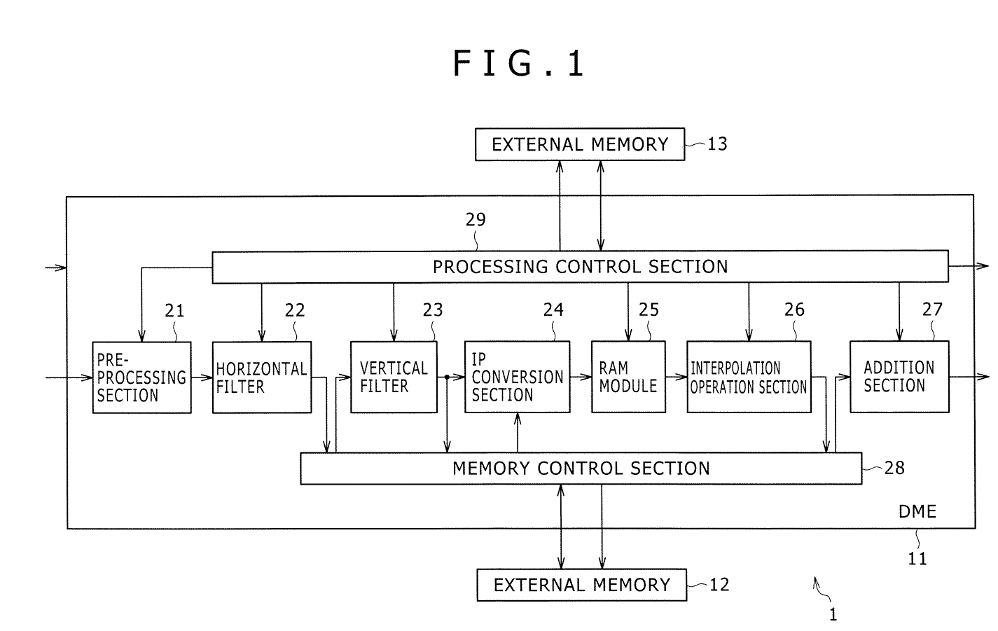

FIG. 1 shows an example of a configuration of an image processing system to which the present invention is applied.

Referring to FIG. 1, the image processing system 1 shown includes a digital image special effect apparatus (Digital Multi Effects apparatus) (hereinafter referred to simply as DME) 11, an external memory 12, and another external memory 13. The image processing system 1 performs reduction, enlargement, change of the type, rotation, leftward and rightward reversal, inversion or movement of an input image which is an image of a unit of a field inputted thereto or applies a special effect to an input image to transform the input image and outputs a resulting image of a unit of a frame. The special effect may be, for example, a mosaic effect, a postalization effect, a negative/positive reversal effect or a defocusing effect in the horizontal direction or the vertical direction.

It is to be noted that the input image is formed from pixel values which represent a luminance signal, a color difference signal and a key signal, which is used for keying, of pixels. Further, the components of the image processing system 1 execute various processes in accordance with a program stored in the external memory 13.

The DME 11 is formed from, for example, an IC (Integrated Circuit), an LSI or the like. The DME 11 includes a pre-processing section 21, a horizontal filter 22, a vertical filter 23, an IP (Interlace Progressive) conversion section 24, a RAM (Random Access Memory) module 25, an interpolation operation section 26, an addition section 27, a memory control section 28 and a processing control section 29.

The DME 11 receives an input image, which is an image to be applied upon texture mapping, and a timing signal supplied thereto. The input image is supplied to the pre-processing section 21. The timing signal is supplied to the components of the DME 11 so that the components may perform respective processes in response to the timing signal.

The pre-processing section 21 applies such special effects as mosaic, postalization and positive/negative reversal effects to the input image in response to an instruction signal supplied thereto from the processing control section 29. In particular, the pre-processing section 21 performs a filtering process for predetermined ones of pixels, which form the input image, in a unit of a pixel thereby to apply a mosaic effect to the input image. Further, the pre-processing section 21 changes the number of gradations of pixel values of the pixels which form the input image thereby to apply postalization to the input image. Furthermore, the pre-processing section 21 reverses the gradations of the pixel values of the pixels which form the input image thereby to apply positive/negative reversal to the input image. The pre-processing section 21 supplies an image of a unit of a field obtained as a result of the application of special effects to the horizontal filter 22.

The horizontal filter 22 receives a reduction ratio in the horizontal direction supplied thereto from the processing control section 29. Then, in order to remove aliasing components in the horizontal direction which appear when an image is reduced, the horizontal filter 22 performs a filtering process corresponding to the received reduction ratio in the horizontal direction for an image in a unit of a field received from the pre-processing section 21. Further, the horizontal filter 22 applies defocusing in the horizontal direction as a special effect to the image in a unit of a field from the pre-processing section 21 in response to an instruction signal supplied thereto from the processing control section 29. The horizontal filter 22 supplies an image of a unit of a field obtained as a result of the application of the filtering process or the defocusing process in the horizontal direction to the external memory 12 through the memory control section 28 so that the image is stored into the external memory 12.

The vertical filter 23 receives a reduction ratio in the vertical direction supplied thereto from the processing control section 29. Further, in order to remove aliasing components in the vertical direction, which appear when an image is reduced, the vertical filter 23 performs a filtering process corresponding to the received reduction ratio in the vertical direction for an image in a unit of a field supplied thereto from the memory control section 28 and read out in the vertical direction from the external memory 12. Further, the vertical filter 23 performs defocusing in the vertical direction as a special effect for the image in a unit of a field from the memory control section 28 in response to an instruction signal supplied thereto from the processing control section 29. The vertical filter 23 supplies an image of a unit of a field obtained as a result of the application of the filtering process or the defocusing process in the vertical direction to the IP conversion section 24. The vertical filter 23 supplies the image also to the external memory 12 through the memory control section 28 so that the image is stored into the external memory 12.

The IP conversion section 24 IP converts an image (interlaced image) in a unit of a field supplied thereto from the vertical filter 23 by referring to another image of a unit of a field immediately preceding to the image and a further image of a unit of a field preceding to the immediately preceding image. Both preceding images are supplied from the memory control section 28 to the IP conversion section 24. The IP conversion section 24 supplies an image (progressive image) of a unit of a frame obtained as a result of the IP conversion to the RAM module 25.

The RAM module 25 stores an image in a unit of a frame from the IP conversion section 24. Further, the RAM module 25 reads out, based on the integral part RXAddr of the coordinate value in the horizontal direction and the integral part RYAddr of the coordinate value in the vertical direction of the coordinates of those pixels (hereinafter referred to as interpolation pixels) which make an object of interpolation operation by the interpolation operation section 26 on the input image, a plurality of pixel values of different pixels to be used for interpolation from among pixel values of pixels which compose an image in a unit of a frame stored already in the RAM module 25. The RAM module 25 supplies the read out pixel values as a pixel value group to the interpolation operation section 26. It is to be noted that the integral parts RXAddr and RYAddr of the coordinate values in the horizontal direction and the vertical direction are supplied from the processing control section 29 to the RAM module 25.

It is to be noted that, as regards the coordinate system on the input image, the center of the pixel at the left upper corner of the input image is determined as the origin of the coordinate system. Further, it is assumed that one pixel has sides of a length of one, and the coordinate values of the center of one pixel are defined as the coordinate values of the pixel. Thus, on the coordinate system on the input image, the coordinate values of the pixels which compose the input image are integral values.

The interpolation operation section 26 performs interpolation operation (filtering arithmetic operation) based on values of the decimal part of the coordinate values in the horizontal and vertical directions of the coordinates of interpolation pixels on the input image supplied from the processing control section 29 and a pixel value group supplied from the RAM module 25 to interpolate the pixel values of the interpolation pixels to perform texture mapping. The interpolation operation section 26 supplies an image in a unit of a frame after interpolation as an image after reduction, enlargement, type change, rotation, leftward-rightward reversal, inversion or movement to the external memory 12 through the memory control section 28 so as to be stored into the external memory 12.

The addition section 27 applies shading using a writing coefficient for each interpolation pixel supplied thereto from the processing control section 29. The addition section 27 outputs an image after the addition as an image after transform.

The memory control section 28 controls writing into and reading out from the external memory 12. In particular, the memory control section 28 supplies a control signal for controlling writing into the external memory 12 to the external memory 12 and supplies an image supplied from the horizontal filter 22, vertical filter 23 or interpolation operation section 26 to the external memory 12 so that the image is written into the external memory 12.

Further, the memory control section 28 supplies a control signal for controlling reading out of an image from the external memory 12 to the external memory 12 to control reading out from the external memory 12. Furthermore, the memory control section 28 supplies an image read out from the external memory 12 as a result of the control to the vertical filter 23, IP conversion section 24 and addition section 27.

The processing control section 29 controls the components of the image processing system 1 in response to an instruction from a user to transform an input image. It is to be noted that the processing control section 29 stores an intermediate result of arithmetic operation or a result of arithmetic operation suitably into the external memory 13.

In particular, the processing control section 29 supplies an instruction signal for the instruction of a mosaic, postalization or negative/positive reversal effect to the pre-processing section 21. Further, the processing control section 29 supplies an instruction signal for the instruction of defocusing in the horizontal direction to the horizontal filter 22 or supplies an instruction signal for the instruction of defocusing in the vertical direction to the vertical filter 23.

Further, the processing control section 29 performs such processes as an arithmetic operation process for arithmetically operating coordinate values on a three-dimensional coordinate system of three-dimensional bodies on which an image outputted from the addition section 27 is texture mapped and a projection process for projecting the coordinate values on the three dimensional coordinate system to coordinate values of a two-dimensional coordinate system in response to an instruction from the user. The processing control section 29 determines, based on a result of the processes, reduction ratios in the horizontal direction and the vertical direction of an image after reduction, enlargement, change of the type, rotation, leftward and rightward reversal, inversion or movement of the image and coordinate values of the pixels in the horizontal direction and the vertical direction. Then, the processing control section 29 controls the input image so as to be reduced, enlarged, changed in type, rotated, reversed in the leftward and rightward directions, inverted or moved.

The processing control section 29 supplies the reduction ratio in the horizontal direction to the horizontal filter 22 and supplies the reduction ratio in the vertical direction to the vertical filter 23. Further, the processing control section 29 supplies the coordinate values in the horizontal direction and the vertical directions of the pixels after reduction, enlargement, change of the type, rotation, leftward and rightward reversal, inversion or movement of the image as coordinate values of interpolation pixels in the horizontal direction and the vertical direction to the RAM module 25 and the interpolation operation section 26. In particular, the processing control section 29 supplies values of the integral part RXAddr and RYAddr of the coordinate values to the RAM module 25 and supplies the values of the decimal part of the coordinate values to the interpolation operation section 26.

Further, the processing control section 29 controls writing into and reading out from the external memory 13. In particular, the processing control section 29 supplies a control signal for controlling writing into the external memory 13 to the external memory 13 and supplies an intermediate result or a final result of arithmetic operation to the external memory 13 so as to be written into the external memory 13.

Furthermore, the processing control section 29 supplies a control signal for controlling reading out from the external memory 13 to the external memory 13 to control reading out from the external memory 13 thereby to read out information representative of the direction of writing. The processing control section 29 uses the information to arithmetically operate a writing coefficient for each interpolation pixel and supplies the resulting writing coefficients to the addition section 27. Further, the processing control section 29 outputs information representative of the depth of the pixels of the image after reduction, enlargement, change of the type, rotation, leftward and rightward reversal, inversion or movement of the image.

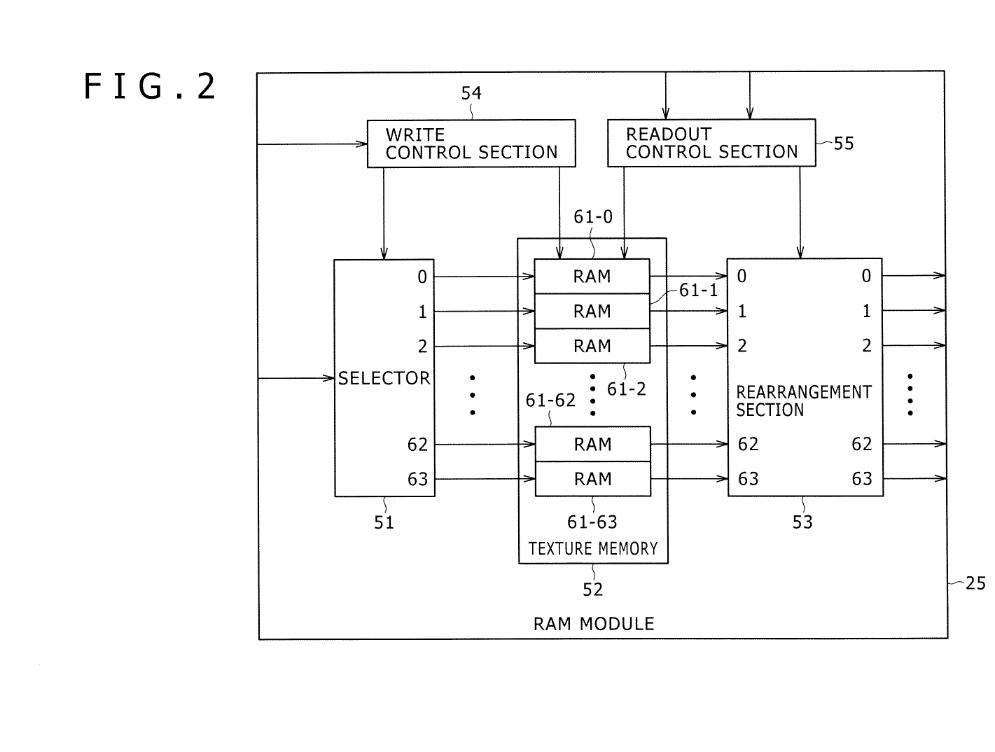

FIG. 2 shows an example of a detailed configuration of the RAM module 25 described hereinabove with reference to FIG. 1.

Referring to FIG. 2, the RAM module 25 shown includes a selector 51, a texture memory 52, a rearrangement section 53, a write control section 54 and a readout control section 55. It is to be noted that it is assumed in the following description that a pixel value group is composed of pixel values of 64 pixels arranged by 8×8 in the horizontal direction and the vertical direction.

The selector 51 receives the pixel values of pixels, which compose an image after IP conversion, one by one from the IP conversion section 24. The selector 51 supplies the pixel values supplied thereto one by one from the IP conversion section 24 and an invalid write enable signal to all RAMs 61-0 to 61-63 which compose the texture memory 52. It is to be noted that, in the following description, where there is no necessity to identify the RAMs 61-0 to 61-63 from each other, they are referred to collectively as RAMs 61.

Further, the selector 51 selects one of the 64 RAMs 61 of the texture memory 52 in response to a selection signal supplied thereto from the write control section 54 and validates the write enable signal to be supplied to the selected RAM 61.

The texture memory 52 is composed of 64 independently controllable RAMs 61-0 to 61-63 equal to the number of pixel values of a pixel value group and stores an image for one frame. Each of the RAMs 61 stores a pixel value supplied thereto from the selector 51 into a write address RamWrAddr supplied thereto from the write control section 54 together with a valid write enable signal in accordance with the write address RamWrAddr and the valid write enable signal. Further, the 64 RAMs 61 read out, based on a read address RamReAddr supplied thereto from the readout control section 55, the pixel values stored in the read address RamReAddr simultaneously as a pixel value group and supplies the read out pixel values to the rearrangement section 53.

The rearrangement section 53 rearranges a pixel value group composed of 64 pixel values supplied from the 64 RAMs 61 in accordance with a control signal supplied thereto from the readout control section 55. In particular, the rearrangement section 53 rearranges the order of the 64 pixel values so that the order of the 64 pixel values which compose the pixel value group and the positions of the pixels corresponding to the pixel values with respect to interpolation pixels may become predetermined ones in accordance with the control signal. Then, the rearrangement section 53 supplies the 64 pixel values after the rearrangement to the interpolation operation section 26.

A timing signal which is supplied to the DME 11 is supplied to the write control section 54. The write control section 54 recognizes the coordinate value WXAddr in the horizontal direction and the coordinate value WYAddr in the vertical direction of a pixel corresponding to a pixel value inputted to the RAM module 25 on the coordinate system of the input image in response to the timing signal. The write control section 54 determines, based on the coordinate values WXAddr and WYAddr, that one of the RAMs 61 and an address of the RAM 61 into which the pixel value inputted to the selector 51 is to be stored. Then, the write control section 54 produces a selection signal representative of the number RamNo of the selected RAM 61 and the write address RamWrAddr representative of the address. It is to be noted that the number RamNo is applied successively in order from zero to the RAMs 61-0 to 61-63.

Then, the write control section 54 supplies the selection signal to the selector 51 and supplies the write address RamWrAddr to the RAM 61 to control writing into the RAM 61.

The readout control section 55 determines the address of the RAMs 61 in which the pixel values of a pixel value group are stored based on the integral parts RXAddr and RYAddr supplied thereto from the processing control section 29 and produces a read address RamReAddr representative of the address. Then, the readout control section 55 supplies the read address RamReAddr to the RAMs 61-0 to 61-63 to control reading out of the RAMs 61.

Further, the readout control section 55 produces the integral parts RXAddr and RYAddr supplied thereto from the processing control section 29 as a control signal and supplies the control signal to the rearrangement section 53.

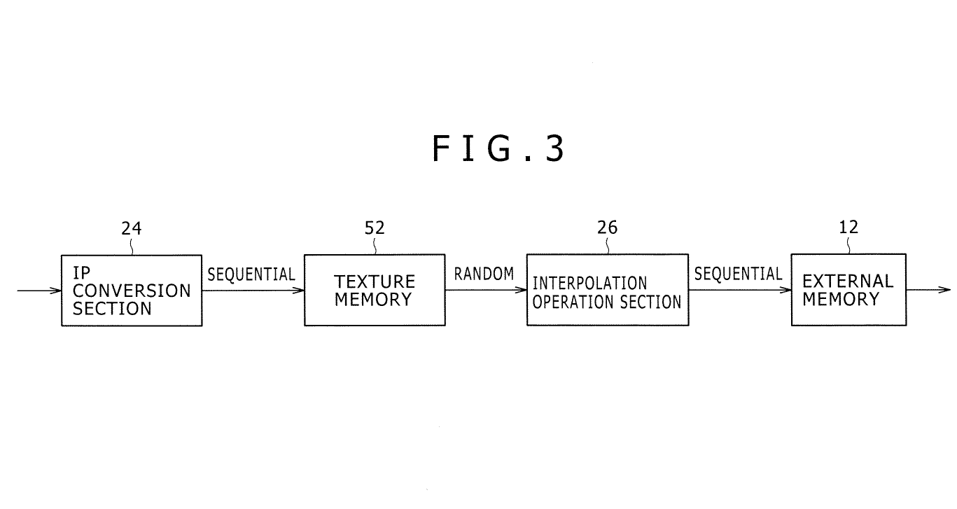

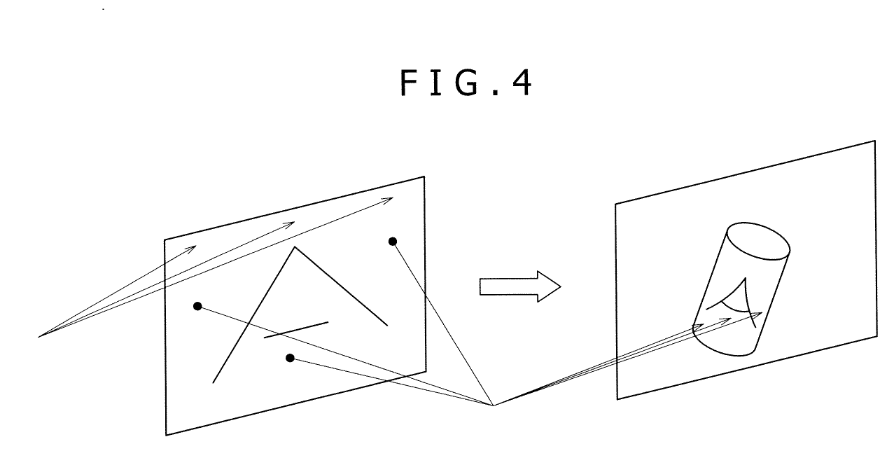

Now, flows of pixel values before and after interpolation operation are described in detail with reference to FIGS. 3 and 4.

As seen in FIG. 3, the IP conversion section 24 IP converts an image in a unit of a field by referring to another image of a unit of a field immediately preceding to the image and a further image of a unit of a field immediately preceding to the immediately preceding image. Then, the IP conversion section 24 supplies the pixel values of pixels which compose the image of a unit of a frame obtained by the IP conversion sequentially (in a scanning order) one by one to the texture memory 52 through the selector 51.

In the texture memory 52, every time one pixel value is supplied from the IP conversion section 24, the valid write enable signal is supplied to a RAM 61 from the selector 51 so that the pixel value is stored into the write address RamWrAddr of the RAM 61. In other words, the texture memory 52 stores the pixel values supplied thereto from the IP conversion section 24 sequentially one by one.

Then, the 64 RAMs 61-0 to 61-63 of the texture memory 52 randomly read out the pixel value group composed of 64 pixel values to be used for interpolation based on the read address RamReAddr supplied thereto from the readout control section 55 so that the pixel values of the interpolation pixels may be outputted sequentially (in a scanning order) from the interpolation operation section 26. The pixel value group read out in this manner is supplied to the interpolation operation section 26.

The interpolation operation section 26 uses the pixel value group supplied from the texture memory 52 to determine the pixel values of the interpolation pixels one by one and supplies the determined pixel values to the external memory 12. As a result, the pixel values of the interpolation pixels are sequentially outputted to the external memory 12.

The external memory 12 serves as a screen memory and sequentially stores the pixel values supplied thereto from the interpolation operation section 26 one by one. Then, the external memory 12 outputs the stored pixel values of the interpolation pixels sequentially.

In particular, as illustrated on the left side in FIG. 4, the pixel values supplied sequentially one by one from the IP conversion section 24 are written into the texture memory 52. Then, the texture memory 52 randomly reads out the pixel value group to be used for interpolation so that the pixel values of the interpolation pixels are outputted sequentially (in a scanning order) one by one from the interpolation operation section 26.

The interpolation operation section 26 uses the pixel value group to perform interpolation and output the pixel values of the interpolation pixels sequentially one by one. Consequently, the pixel values of the interpolation pixels are written sequentially one by one into the external memory 12 as illustrated on the right side in FIG. 4.

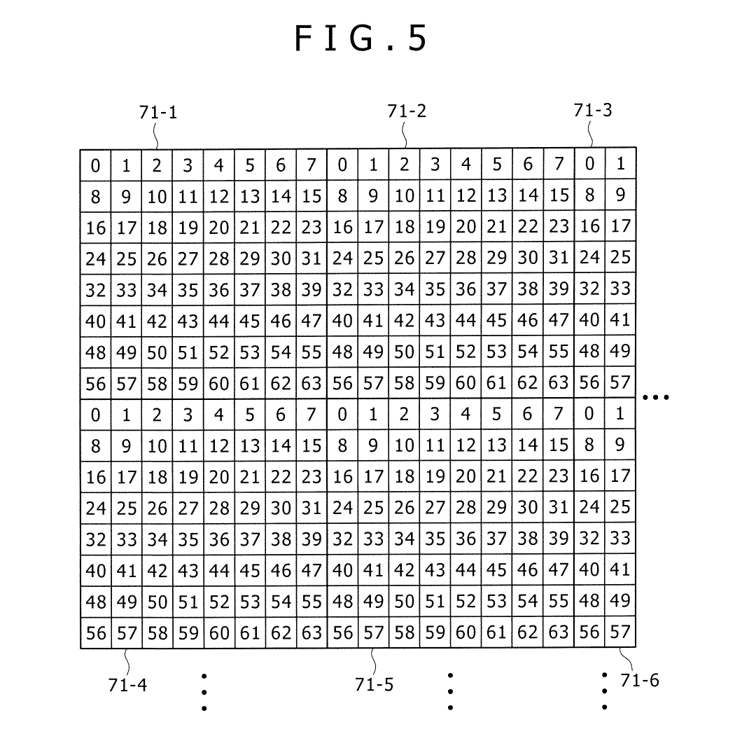

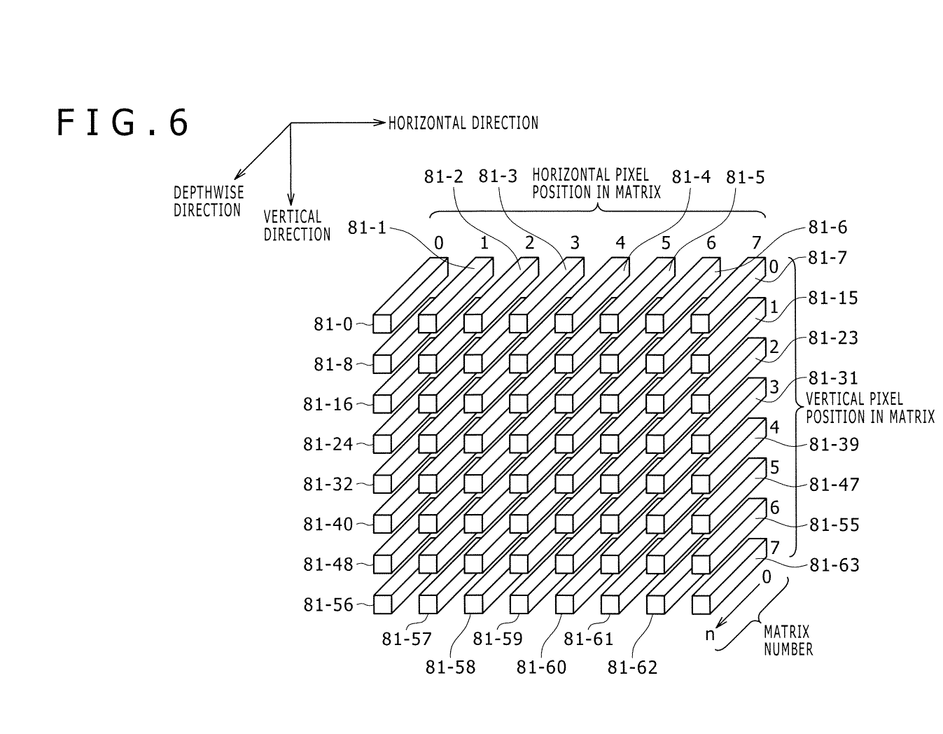

Now, the write address RamWrAddr produced by the write control section 54 shown in FIG. 2 is described with reference to FIGS. 5 and 6.

First, the write control section 54 determines the coordinate values WXAddr[n:0] and WYAddr[m:0] of a pixel corresponding to a pixel value inputted to the selector 51 in response to a timing signal. For example, where the number of pixels of the input image in the horizontal direction is 1,920 and the number of pixels in the vertical direction is 1,080, n=m=10.

Then, the write control section 54 determines the number RamNo of that one of the RAMs 61 into which the pixel value inputted to the selector 51 is to be inputted in accordance with the following expression (1) based on the coordinate values WXAddr[n:0] and WYAddr[m:0]:

RamNo[5:0]={WYAddr[2:0], WXAddr[2:0]} (1)

According to the expression (1), the numbers of the RAMs 61 into which the pixel value of each of pixels which compose an image after IP conversion which is divided into 8×8 matrices 71-1, 71-2, 71-3, 71-4, 71-5, 71-6, . . . are the same number RamNo where the positions in the matrices 71-1, 71-2, 71-3, 71-4, 71-5, 71-6, . . . are same. In other words, an image after IP conversion is divided in 8×8 matrices, and the pixel values of pixels in the same matrix are stored into different ones of the RAMs 61.

It is to be noted that, in FIG. 5, each square in the matrices 71 represents a pixel, and the number in each square represents the number RamNo. It is to be noted that, in the following description, where there is no necessity to identify the matrices 71-1, 71-2, 71-3, 71-4, 71-5, 71-6, . . . from each other, they are referred to collectively as matrices 71.

The write control section 54 produces the number RamNo determined using the expression (1) as a selection signal and supplies the selection signal to the selector 51.

As described above, the write control section 54 produces a selection signal such that an image after IP conversion is divided into 8×8 matrices 71 of a size same as that of a pixel value group and the pixel values of the pixels in the same matrix 71 are stored into different ones of the RAMs 61. Therefore, the pixel values which compose a pixel value group are stored in a unit of a pixel value group into different ones of the RAMs 61 for the individual pixels. In other words, the write control section 54 controls the RAMs 61 so that the pixel values which compose a pixel value group are stored individually into different ones of the RAMs 61.

As a result, the 64 RAMs 61 which compose the texture memory 52 can read out the pixel values which compose a pixel value group 101 at the same time therefrom. Consequently, the DME 11 can perform interpolation with a high degree of accuracy while suppressing increase of the power consumption and the circuit scale.

Further, the write control section 54 determines the write address RamWrAddr in accordance with the expression (2) given below based on the coordinate values WXAddr[n:0] and WYAddr[m:0] and the total number MatrixNo of the matrices 71 in the horizontal direction which compose the input image. It is to be noted that the total number MatrixNo is set in advance based on the number of pixels in the horizontal direction of the input image. For example, where the number of pixels in the horizontal direction of the input image is 1,920, the total number MatrixNo is set to 240 (=1,920/8).

RamWrAddr[k:0]=(WYAddr[m:2]×HMatrixNo[1:0]+WXAddr[n:2] (2)

According to the expression (2), the write address RamwrAddr is set in order from zero such that the write address RamWrAddr of the pixel value of each of pixels having positions same as each other in the matrices 71 increases from a pixel at the left upper corner toward another pixel at the right lower corner. In particular, where the matrices 71 are numbered such that the positions of the matrices 71 increase from the left upper corner toward the right lower corner, the number of each of the matrices 71 is represented by the write address RamWrAddr. It is to be noted that, in the following description, the matrices 71 are presumably numbered such that the positions thereof increase from the left upper corner toward the right lower corner.

A concept of the texture memory 52 in which pixel values are stored using the selection signal and the write address RamWrAddr produced in such a manner as described above is described with reference to FIG. 6.

In FIG. 6, 64 rectangular parallelepipeds 81-0 to 81-63 represent the RAMs 61-0 to 61-63, respectively. It is to be noted that, in the following description, where there is no necessity to identify the rectangular parallelepipeds 81-0 to 81-63 from each other, they are referred to collectively as rectangular parallelepipeds 81. Further, the length of the rectangular parallelepipeds 81 in the depthwise direction of FIG. 6, that is, in the direction from the interior side toward this side in FIG. 6, represents the address of the RAMs 61.

As seen in FIG. 6, the RAMs 61 of the texture memory 52 correspond to the positions of the pixels, which compose the matrix 71, in the horizontal direction and the vertical direction in the matrix 71, and a RAM 61 into which a pixel value is to be stored is selected depending upon the position of a pixel corresponding to the pixel value in the horizontal direction and the vertical direction in the matrix 71. For example, the pixel value of a pixel whose position in the horizontal direction is zero and whose position in the vertical direction is one is stored into the RAM 61-8 represented by the rectangular parallelepiped 81-8 which corresponds to the positions in the horizontal direction and the vertical direction.

Meanwhile, each of the RAMs 61 stores the pixel value of a pixel at the positions in the horizontal direction and the vertical direction corresponding to the RAM 61 itself in all of the matrices 71 which compose an image after IP conversion into the write address RamWrAddr which is the number of the matrix 71 which includes the pixel. For example, the pixel value of each of the pixels which compose the matrix 71-1 whose matrix number is one is written into the regions whose address is one in the RAMs 61-0 to 61-63 represented by the rectangular parallelepipeds 81-0 to 81-63.

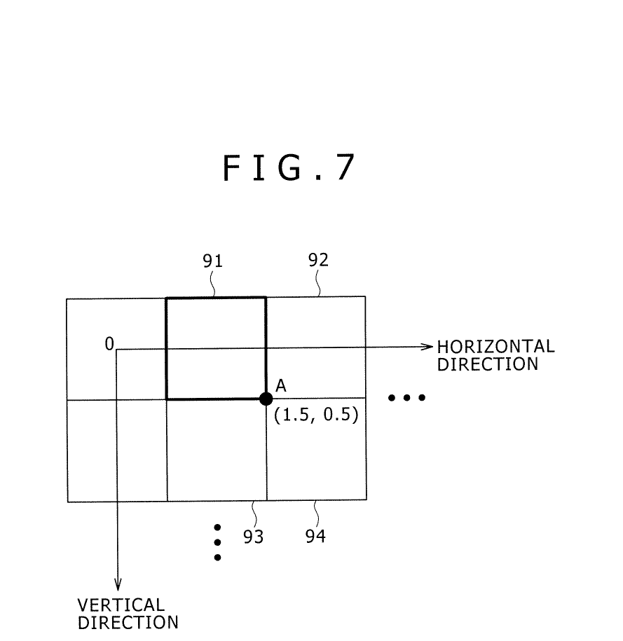

Now, the read address RamReAddr produced by the readout control section 55 shown in FIG. 2 is described with reference to FIG. 7.

The readout control section 55 receives the integral parts RXAddr and RYAddr supplied thereto from the processing control section 29. The integral parts RXAddr and RYAddr are described with reference to FIG. 7.

FIG. 7 illustrates the integral parts RXAddr[n:0] and RYAddr[m:0].

In the example of FIG. 7, it is assumed that the coordinate values of an interpolation pixel are the central point A(1.5, 0.5) of the interpolation pixel, and the integral parts RXAddr and RYAddr are one and zero, respectively.

As seen in FIG. 7, the coordinate values (1, 0) represented by the integral parts RXAddr and RYAddr are coordinate values of a pixel 91 which is a left upper one of four pixels 91 to 94 positioned around the central point A of the interpolation pixel.

The readout control section 55 determines, based on the integral parts RXAddr and RYAddr and the total number HMatrixNo, the number Mt11Addr of the matrix 71 in which the pixel 91 of the coordinate values represented by the integral parts RXAddr and RYAddr is included in accordance with the following expression (3):

Mt11Addr[k:0]=(RYAddr[m:2]×HMatrixNo[1:0]+RXAddr[n:2] (3)

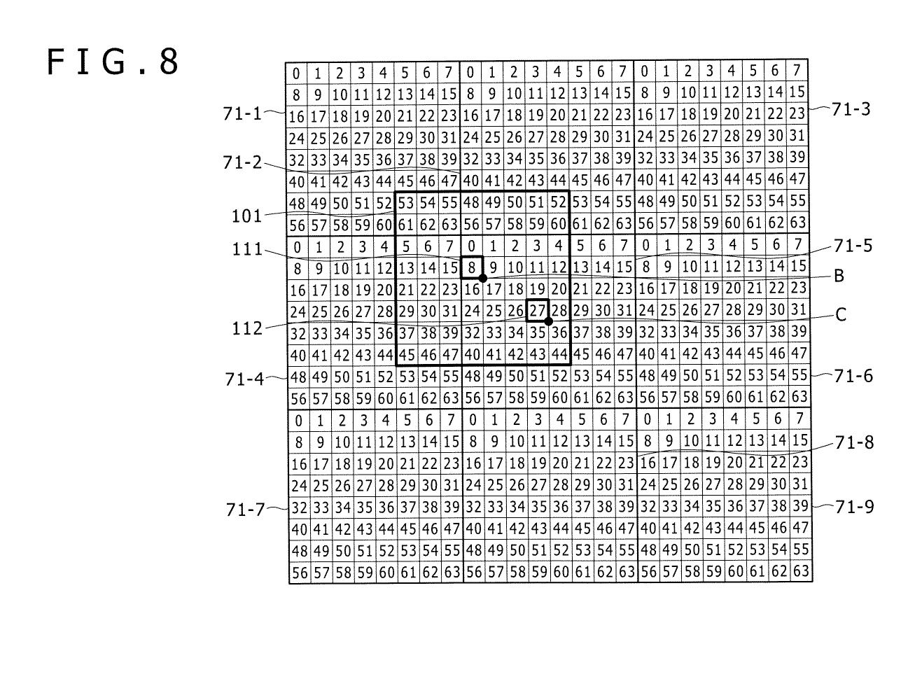

Here, if the matrix 71 of the number Mt11Addr is the matrix 71-5 as seen in FIG. 8, then the pixel value group 101 to be used for interpolation of an interpolation pixel is composed of pixels of the four matrices 71-1, 71-2, 71-4 and 71-5 in the maximum around the matrix 71-5, the matrices 71-2, 71-3, 71-5 and 71-6, the matrices 71-4, 71-5, 71-7 and 71-8, or the matrices 71-5, 71-6, 71-8 and 71-9, which all include the matrix 71-5. In other words, the pixel value group 101 is composed of pixels in four matrices including the matrix 71-5 from among the nine matrices 71-1 to 71-9.

Therefore, the readout control section 55 determines the numbers Mt01Addr to Mt04Addr of the matrices 71-1 to 71-4 and the numbers Mt06Addr to Mt09Addr of the matrices 71-6 to 71-9 in accordance with the following expressions (4):

Mt01Addr[k:0]=Mt11Addr[k:0]−HMatrixNo[1:0]−1

Mt02Addr[k:0]=Mt11Addr[k:0]−HMatrixNo[1:0]

Mt03Addr[k:0]=Mt11Addr[k:0]−HMatrixNo[1:0]+1

Mt04Addr[k:0]=Mt11Addr[k:0]−1

Mt06Addr[k:0]=Mt11Addr[k:0]+1

Mt07Addr[k:0]=Mt11Addr[k:0]+HMatrixNo[1:0]−1

Mt08Addr[k:0]=Mt11Addr[k:0]+HMatrixNo[1:0]

Mt09Addr[k:0]=Mt11Addr[k:0]+HMatrixNo[1:0]+1

Here, the relationship between the number RamNo and the position HPosition in the horizontal direction and position VPosition in the vertical direction of the pixel corresponding to the RAM 61 of the RamNo on the matrix 71 which includes the pixel is represented by the following expressions (5). It is to be noted that the positions HPosition and VPosition are coordinate values on the coordinate system whose origin is the center of the pixel at the left upper corner of the matrix 71.

HPosition[2:0]=RamNo[2:0]

VPosition[2:0]=RamNo[5:3] (5)

The readout control section 55 sets, based on the values of the integral parts RXAddr and RYAddr, the values of a parameter Hparameter in the horizontal direction according to the expression (6) given below and a parameter Vparameter in the vertical direction according to the expression (7) given below in the RAM 61 corresponding to the pixel positioned at the positions HPosition and VPosition.

When RXAddr[2:0]=0,

Hparameter=1 for the RAMs 61 whose HPosition is 0 to 4

Hparameter=0 for the RAMs 61 whose HPosition is 5 to 7

When RXAddr[2:0]=1,

Hparameter=1 for the RAMs 61 whose HPosition is 0 to 5

Hparameter=0 for the RAMs 61 whose HPosition is 6 and 7

When RXAddr[2:0]=2,

Hparameter=1 for the RAMs 61 whose HPosition is 0 to 6

Hparameter=0 for the RAM 61 whose HPosition is 7

When RXAddr[2:0]=3,

Hparameter=1 for the RAMs 61 whose HPosition is 0 to 7

When RXAddr[2:0]=4,

Hparameter=2 for the RAM 61 whose HPosition is 0

Hparameter=1 for the RAMs 61 whose HPosition is 1 to 7

When RXAddr[2:0]=5,

Hparameter=2 for the RAMs 61 whose HPosition is 0 and 1

Hparameter=1 for the RAMs 61 whose HPosition is 2 to 7

When RXAddr[2:0]=6,

Hparameter=2 for the RAMs 61 whose HPosition is 0 to 2

Hparameter=1 for the RAMs 61 whose HPosition is 3 to 7

When RXAddr[2:0]=7,

Hparameter=2 for the RAMs 61 whose HPosition is 0 to 3

Hparameter=1 for the RAMs 61 whose HPosition is 4 to 7 (6)

When RYAddr[2:0]=0,

Vparameter=1 for the RAMs 61 whose VPosition is 0 to 4

Vparameter=0 for the RAMs 61 whose VPosition is 5 to 7

When RYAddr[2:0]=1,

Vparameter=1 for the RAMs 61 whose VPosition is 0 to 5

Vparameter=0 for the RAMs 61 whose VPosition is 6 and 7

When RYAddr[2:0]=2,

Vparameter=1 for the RAMs 61 whose VPosition is 0 to 6

Vparameter=0 for the RAM 61 whose VPosition is 7

When RYAddr[2:0]=3,

Vparameter=1 for the RAMs 61 whose VPosition is 0 to 7

When RYAddr[2:0]=4,

Vparameter=2 for the RAM 61 whose VPosition is 0

Vparameter=1 for the RAMs 61 whose VPosition is 1 to 7

When RYAddr[2:0]=5,

Vparameter=2 for the RAMs 61 whose VPosition is 0 and 1

Vparameter=1 for the RAMs 61 whose VPosition is 2 to 7

When RYAddr[2:0]=6,

Vparameter=2 for the RAMs 61 whose VPosition is 0 to 2

Vparameter=1 for the RAMs 61 whose VPosition is 3 to 7

When RYAddr[2:0]=7,

Vparameter=2 for the RAMs 61 whose VPosition is 0 to 3

Vparameter=1 for the RAMs 61 whose VPosition is 4 to 7 (7)

It is to be noted that, in the expressions (6), the parameter Hparameter represents the positional relationship in the horizontal direction between the matrix 71 in which the pixels which compose the pixel value group 101 are included and the matrix 71 of the number Mt11Addr (in the example of FIG. 8, the matrix 71-5). Meanwhile, in the expressions (7), the parameter Vparameter represents the positional relationship in the vertical direction between the two matrices 71.

In particular, where the parameter Hparameter is zero, this represents that the matrix 71 in which the pixel corresponding to the RAM 61 in which the parameter Hparameter is set is included is positioned just on the left side of the matrix 71 of the number Mt11Addr. On the other hand, where the parameter Hparameter is one, this represents that the matrix 71 in which the pixel corresponding to the RAM 61 in which the parameter Hparameter is set is included and the matrix 71 of the number Mt11Addr are positioned at the same position. Further, where the parameter Hparameter is two, the matrix 71 in which the pixel corresponding to the RAM 61 in which the parameter Hparameter is set is included is positioned just on the right side of the matrix 71 of the number Mt11Addr.

Meanwhile, where the parameter Vparameter is zero, this represents that the matrix 71 in which the pixel corresponding to the RAM 61 in which the parameter Vparameter is set is included is positioned just on the upper side of the matrix 71 of the number Mt11Addr. On the other hand, where the parameter Vparameter is one, this represents that the matrix 71 in which the pixel corresponding to the RAM 61 in which the parameter Vparameter is set is included and the matrix 71 of the number Mt11Addr are positioned at the same position. Further, where the parameter Vparameter is two, the matrix 71 in which the pixel corresponding to the RAM 61 in which the parameter Vparameter is set is included is positioned just on the lower side of the matrix 71 of the number Mt11Addr.

Accordingly, the readout control section 55 produces, based on the values of the parameters Hparameter and Vparameter, a read address RamReAddr in accordance with the following expressions for the RAM 61 to which the values are set. The read address RamReAddr produced in this manner is supplied to the RAM 61.

(Read address RamReAddr to be provided to RAM 61 whose Vparameter=0 and whose Hparameter=0) Mt01Addr[k:0]

(Read address RamReAddr to be provided to RAM 61 whose Vparameter=0 and whose Hparameter=1) Mt02Addr[k:0]

(Read address RamReAddr to be provided to RAM 61 whose Vparameter=0 and whose Hparameter=2)=Mt03Addr[k:0]

(Read address RamReAddr to be provided to RAM 61 whose Vparameter=1 and whose Hparameter=0)=Mt04Addr[k:0]

(Read address RamReAddr to be provided to RAM 61 whose Vparameter=1 and whose Hparameter=1)=Mt05Addr[k:0]

(Read address RamReAddr to be provided to RAM 61 whose Vparameter=1 and whose Hparameter=2)=Mt06Addr[k:0]

(Read address RamReAddr to be provided to RAM 61 whose Vparameter=2 and whose Hparameter=0)=Mt07Addr[k:0]

(Read address RamReAddr to be provided to RAM 61 whose Vparameter=2 and whose Hparameter=1)=Mt08Addr[k:0]

(Read address RamReAddr to be provided to RAM 61 whose Vparameter=2 and whose Hparameter=2)=Mt09Addr[k:0]

Now, a control signal produced by the readout control section 55 shown in FIG. 2 is described.

Here, it is assumed that the rearrangement section 53 has input terminals to which pixel values are inputted from the RAMs 61-0 to 61-63 and which have numbers from 0 to 63 applied thereto in order. Also it is assumed that, also to output terminals of the rearrangement section 53 from which pixel values are outputted, numbers from 0 to 63 are applied in order, and the numbers correspond to the positions of pixels which compose the pixel value group 101.

The readout control section 55 produces the integral parts RXAddr and RYAddr as a control signal and supplies the control signal to the rearrangement section 53.

The rearrangement section 53 outputs a pixel value inputted thereto from an input terminal of the number CPSinNo thereof from an output terminal of the number CPSoutNo.

In particular, the number CPSinNo[2:0] is defined by the expressions (9) given below based on the integral part RXAddr and the number CPSoutNo[2:0] It is to be noted that i→j in the expressions (9) represents that a pixel value inputted from an input terminal having the number CPSinNo whose higher three bits are i is outputted from an output terminal having the number CPSoutNo whose higher three bits are j.

When RXAddr[2:0]=0,0→3,1→4,2→5,3→6,4→7,5→0, 6→1,7→2

When RXAddr[2:0]=1,0→4,1→5,2→6,3→7,4→0,5→1, 6→2,7→3

When RXAddr[2:0]=2,0→5,1→6,2→7,3→0,4→1,5→2, 6→3,7→4

When RXAddr[2:0]=3,0→6,1→7,2→0,3→1,4→2,5→3, 6→4,7→5

When RXAddr[2:0]=4,0→7,1→0,2→1,3→2,4→3,5→4, 6→5,7→6

When RXAddr[2:0]=5,0→0,1→1,2→2,3→3,4→4,5→5, 6→6,7→7

When RXAddr[2:0]=6,0→1,1→2,2→3,3→4,4→5,5→6, 6→7,7→0

When RXAddr[2:0]=7,0→2,1→3,2→4,3→5,4→6,5→7, 6→0,7→1 (9)

Meanwhile, the number CPSinNo[5:3] is defined by the expressions (10) given below based on the integral part RXAddr and the number CPSoutNo[5:3]. It is to be noted that I→j in the expression (10) represents that a pixel value inputted from an input terminal having the number CPSinNo whose lower three bits are i is outputted from an output terminal having the number CPSoutNo whose lower three bits are j.

When RXAddr[5:3]=0,0→3,1→4,2→5,3→6,4→7,5→0, 6→1,7→2

When RXAddr[5:3]=1,0→4,1→5,2→6,3→7,4→0,5→1, 6→2,7→3

When RXAddr[5:3]=2,0→5,1→6,2→7,3→0,4→1,5→2, 6→3,7→4

When RXAddr[5:3]=3,0→6,1→7,2→0,3→1,4→2,5→3, 6→4,7→5

When RXAddr[5:3]=4,0→7,1→0,2→1,3→2,4→3,5→4, 6→5,7→6

When RXAddr[5:3]=5,0→0,1→1,2→2,3→3,4→4,5→5, 6→6,7→7

When RXAddr[5:3]=6,0→1,1→2,2→3,3→4,4→5,5→6, 6→7,7→0

When RXAddr[5:3]=7,0→2,1→3,2→4,3→5,4→6,5→7, 6→0,7→1 (10)

According to the expressions (9) and (10), the numbers obtained by increasing the numbers CPSinNo[2:0] and CPSinNo[5:3] of the input terminals by a difference between the position, on the matrix 71-5 which includes the pixel 111, of the pixel 111 positioned leftwardly upwardly of the central point B of an interpolation pixel represented by the integral parts RXAddr and RYAddr, that is, the pixel 111 leftwardly upwardly of the center of the pixel value group 101, and the position of the pixel 112 positioned leftwardly upwardly of the central point C of the matrix 71-5 are determined as the numbers CPSoutNo[2:0] and CPSoutNo[5:3] of the output terminals. It is to be noted that, if the number obtained by such increase exceeds seven, a value obtained by subtracting seven from the number is used.

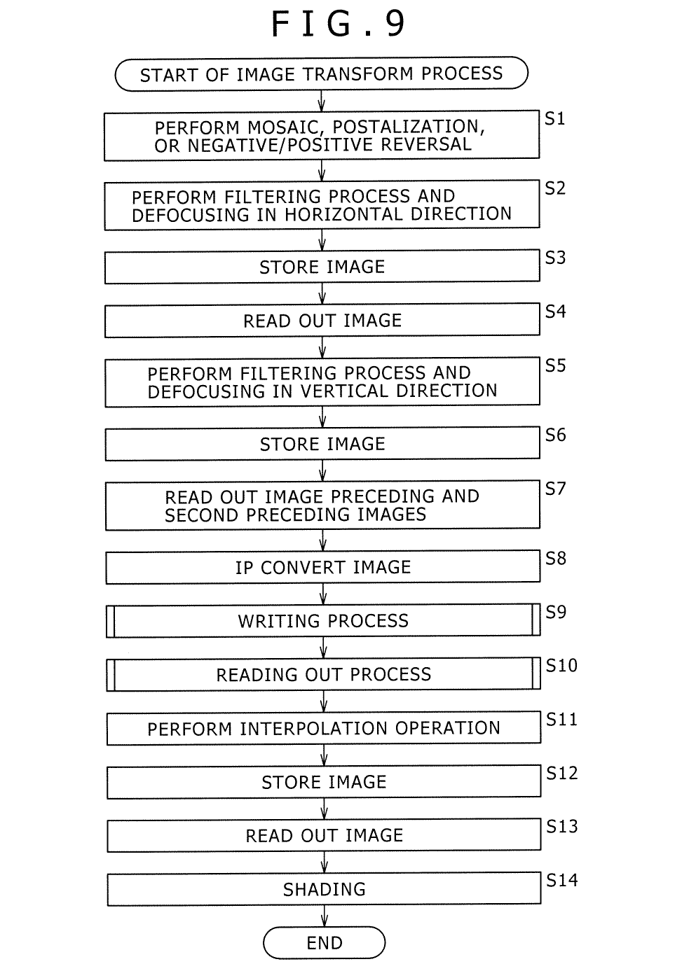

Now, an image transform process executed by the image processing system 1 of FIG. 1 to transform an input image is described with reference to FIG. 9. The image transform process is started, for example, when an input image is inputted to the image processing system 1.

At step S1, the pre-processing section 21 performs such a process as mosaic, postalization or positive/negative reversal for the input image in response to an instruction signal supplied thereto from the processing control section 29. Then, the pre-processing section 21 supplies an image of a unit of a field obtained as a result of the process to the horizontal filter 22, whereafter the processing advances to step S2. It is to be noted that, if an instruction signal is not supplied from the processing control section 29, then the processing skips step S1 and advances to step S2.

At step S2, the horizontal filter 22 performs, in response to a reduction ratio in the horizontal direction supplied thereto from the processing control section 29, a filtering process corresponding to the reduction ratio in the horizontal direction for the image of a unit of a field from the pre-processing section 21. Further, the horizontal filter 22 performs a defocusing process in the horizontal direction as a special effect for the image in response to an instruction signal supplied from the processing control section 29. Then, the horizontal filter 22 supplies the image of a unit of a field obtained as a result of the filtering process and/or the defocusing process in the horizontal direction performed for the image to the memory control section 28.

After the process at step S2, the processing advances to step S3, at which the memory control section 28 supplies the image of a unit of a field supplied thereto from the horizontal filter 22 together with a control signal for controlling writing into the external memory 12 to the external memory 12 so that the image may be stored into the external memory 12. After the process at step S3, the processing advances to step S4, at which the memory control section 28 supplies a control signal for controlling reading out of an image from the external memory 12 to the external memory 12. Consequently, the image of a unit of a field stored at step S3 is read out in the vertical direction from the external memory 12 and supplied to the vertical filter 23.

After the process at step S4, the processing advances to step S5, at which the vertical filter 23 performs, in response to a reduction ratio in the vertical direction supplied from the processing control section 29, a filtering process corresponding to the reduction ratio in the vertical direction for the image of a unit of a field supplied from the memory control section 28. Further, the vertical filter 23 performs a defocusing process in the vertical direction as a special effect for the image of a unit of a field in response to an instruction signal supplied from the processing control section 29. Then, the vertical filter 23 supplies an image in a unit of a field obtained as a result of filtering process and/or the defocusing process to the IP conversion section 24 and also to the memory control section 28.

After the process at step S5, the processing advances to step S6, at which the memory control section 28 supplies the image in a unit of a field supplied from the vertical filter 23 together with a control signal for controlling writing into the external memory 12 to the external memory 12 so that the image is stored into the external memory 12. After the process at step S6, the processing advances to step S7. At step S7, the memory control section 28 supplies a control signal for controlling reading out of the image from the external memory 12 to the external memory 12 to read out the image of a unit of a field immediately preceding to the image of a unit of a field and stored by the process at step S6 in the immediately preceding operation cycle and the immediately preceding image of a unit of a field from the external memory 12 and supplies the read out images to the IP conversion section 24.

After the process at step S7, the processing advances to step S8, at which the IP conversion section 24 refers to the two images supplied thereto from the memory control section 28 at step S7 to IP convert the image of a unit of a field supplied from the vertical filter 23 at step S5. Then, the IP conversion section 24 supplies an image of a unit of a frame obtained as a result of the IP conversion to the RAM module 25.

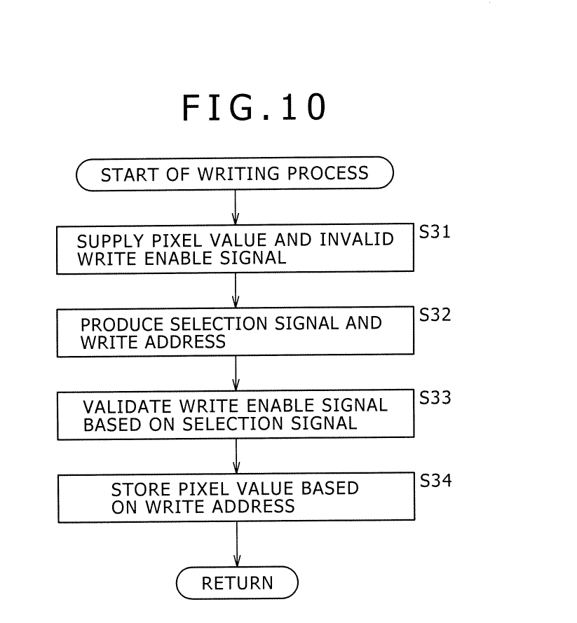

At step S9, the RAM module 25 performs a writing process of writing pixel values into the RAM 61 (FIG. 2) of the texture memory 52. The writing process is hereinafter described with reference to FIG. 10.

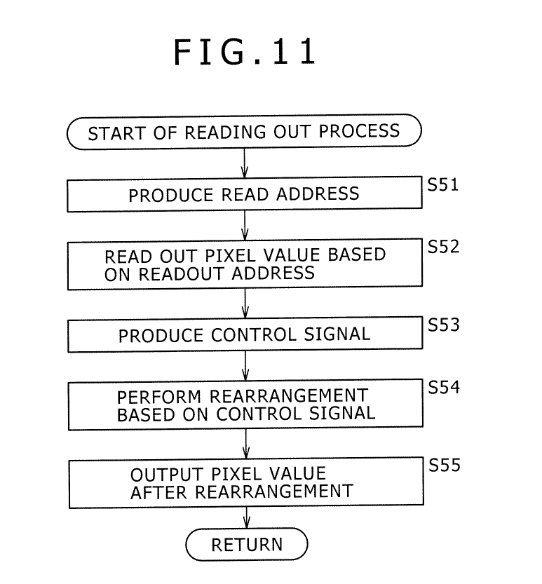

After the process at step S9, the processing advances to step S10, at which the RAM module 25 performs a reading out process of reading out the pixel value group 101 from the RAM 61 of the texture memory 52. This reading out process is hereinafter described with reference to FIG. 11.

After the process at step S10, the processing advances to step S11, at which the interpolation operation section 26 performs, based on the decimal parts of the coordinate values of interpolation pixels in the horizontal direction and the vertical direction on the coordinate system of the input image supplied from the processing control section 29 and the pixel value group 101 supplied from the RAM module 25, interpolation operation to interpolate the pixel values of the interpolation pixels. Then, the interpolation operation section 26 supplies an image of a unit of a frame after the interpolation to the memory control section 28.

After the process at step S11, the processing advances to step S12, at which the memory control section 28 supplies the image from the interpolation operation section 26 together with a control signal for controlling writing into the external memory 12 to the external memory 12 so that the image is stored into the external memory 12. After the process at step S12, the processing advances to step S13, at which the memory control section 28 supplies a control signal for controlling reading out of an image from the external memory 12 to the external memory 12 to read out the image stored at step S12. Thereafter, the processing advances to step S14.

At step S14, the addition section 27 adds shading to the image using a writing coefficient for each interpolation pixel supplied thereto from the processing control section 29. Then, the addition section 27 outputs the image after the addition as an image after the conversion, thereby ending the processing.

It is to be noted that the processes at steps S1 to S9 of the image transform process of FIG. 9 described above are performed in a unit of a pixel before the interpolation, and the processes at steps S10 to S14 are executed in a unit of an interpolation pixel.

Now, the writing process at step S9 of FIG. 9 is described with reference to FIG. 10.

At step S31, the selector 51 of the RAM module 25 supplies the pixel values of the image after the IP conversion supplied thereto from the IP conversion section 24 and an invalid write enable signal to the RAMs 61 of the texture memory 52. Thereafter, the processing advances to step S32.

At step S32, the write control section 54 recognizes the coordinate value WXAddr in the horizontal direction and the coordinate value WYAddr in the vertical direction of a pixel corresponding to the pixel value supplied from the RAM module 25 on the coordinate system of the input image in response to a timing signal. Then, the write control section 54 produces a selection signal representative of a number RamNo and a write address signal RamWrAddr based on the recognized coordinate values WXAddr and WYAddr. Then, the write control section 54 supplies the selection signal to the selector 51 and supplies the write address RamWrAddr to the RAMs 61.

After the process at step S32, the processing advances to step S33, at which the selector 51 selects, in response to the selection signal supplied from the write control section 54 at step S32, the RAM 61 of the number RamNo represented by the selection signal from among the 64 RAMs 61 of the texture memory 52. Then, the selector 51 validates the write enable signal to be supplied to the selected RAM 61.

After the process at step S33, the processing advances to step S34, at which the RAM 61 stores, based on the write address RamWrAddr and the valid write enable signal supplied thereto from the write control section 54, the pixel value supplied thereto from the selector 51 into the write address RamWrAddr thereof. Thereafter, the processing returns to step S9 of FIG. 9 and then advances to step S10.

Now, the reading out process at step S10 of FIG. 9 is described with reference to FIG. 11.

At step S51, the readout control section 55 determines, based on the integral parts RXAddr and RYAddr supplied thereto from the processing control section 29, the addresses of the RAMs 61 in which the pixel values of the pixel value group 101 and produces the read addresses RamReAddr representing the addresses. Then, the readout control section 55 supplies the read addresses RamReAddr individually to the RAMs 61-0 to 61-63.

After the process at step S51, the processing advances to step S52, at which the RAMs 61 read out, based on the read addresses RamReAddr, the pixel values stored in the read addresses RamReAddr simultaneously as the pixel value group 101. Then, the pixel value group 101 thus read out is supplied to the rearrangement section 53. Thereafter, the processing advances to step S53.

At step S53, the readout control section 55 produces the integral parts RXAddr and RYAddr supplied thereto from the processing control section 29 as a control signal and supplies the control signal to the rearrangement section 53. Thereafter, the processing advances to step S54.

At step S54, the rearrangement section 53 rearranges, based on the control signal supplied thereto from the readout control section 55, the pixel value group 101 supplied thereto from the 64 RAMs 61 and composed of 64 pixel values. Thereafter, the processing advances to step S55. At step S55, the rearrangement section 53 supplies the pixel value group 101 after the rearrangement to the interpolation operation section 26. Thereafter, the processing returns to step S10 in FIG. 9 and then advances to step S11.

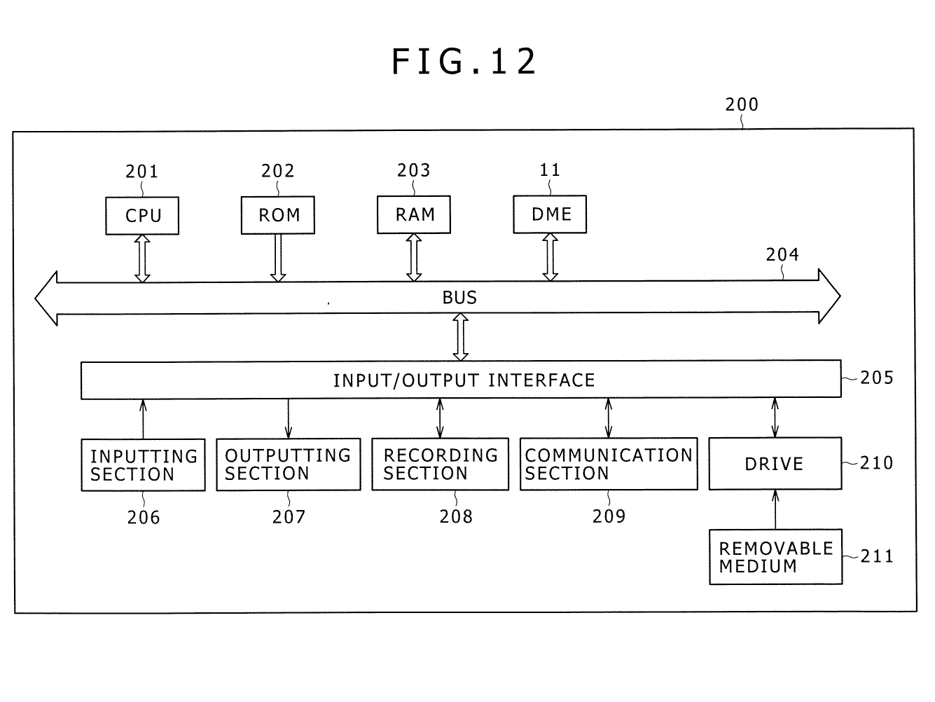

Now, an example of an information processing apparatus 200 in the form of a personal computer in which the DME 11 is incorporated is described with reference to FIG. 12.

The information processing apparatus 200 includes a CPU (Central Processing Unit) 201 and a DME 11 which execute various processes in accordance with a program stored in a ROM (Read Only Memory) 202 or recorded in a recording section 208. A program to be executed by the CPU 201, data to be used by the CPU 201 and so forth are suitably stored into a RAM (Random Access Memory) 203. The DME 11, CPU 201, ROM 202 and RAM 203 are connected to each other by a bus 204.

Also an input/output interface 205 is connected to the CPU 201 through the bus 204. An inputting section 206 including a keyboard, a mouse, a microphone, a reception section for receiving an instruction transmitted from a remote controller not shown and so forth and an outputting section 207 including a display unit, a speaker and so forth are connected to the input/output interface 205. The CPU 201 executes various processes in response to an instruction inputted from the inputting section 206. Then, the CPU 201 outputs results of the processes to the outputting section 207.

For example, the CPU 201 controls the DME 11 in response to an instruction inputted from the inputting section 206 to perform reduction, enlargement, change of the type, rotation, leftward and rightward reversal, inversion or movement of an input image or apply a special effect to an input image. Then, the CPU 201 controls the outputting section 207 to display an image based on an image outputted from the DME 11.

The recording section 208 connected to the input/output interface 205 includes, for example, a hard disk and stores a program to be executed by the CPU 201 and various data. A communication section 209 communicates with an external apparatus through a network such as the Internet or a local area network. For example, the communication section 209 acquires an image from the external apparatus and supplies the image as an input image to the DME 11. It is to be noted that a program recorded in the recording section 208 may be acquired through the communication section 209.

A drive 210 connected to the input/output interface 205 drives a removable medium 211 such as a magnetic disk, an optical disk, a magneto-optical disk or a semiconductor memory when the removable medium 211 loaded therein to acquire a program or data recorded on the removable medium 211. The acquired program or data is transferred to and recorded by the recording section 208 as occasion demands.

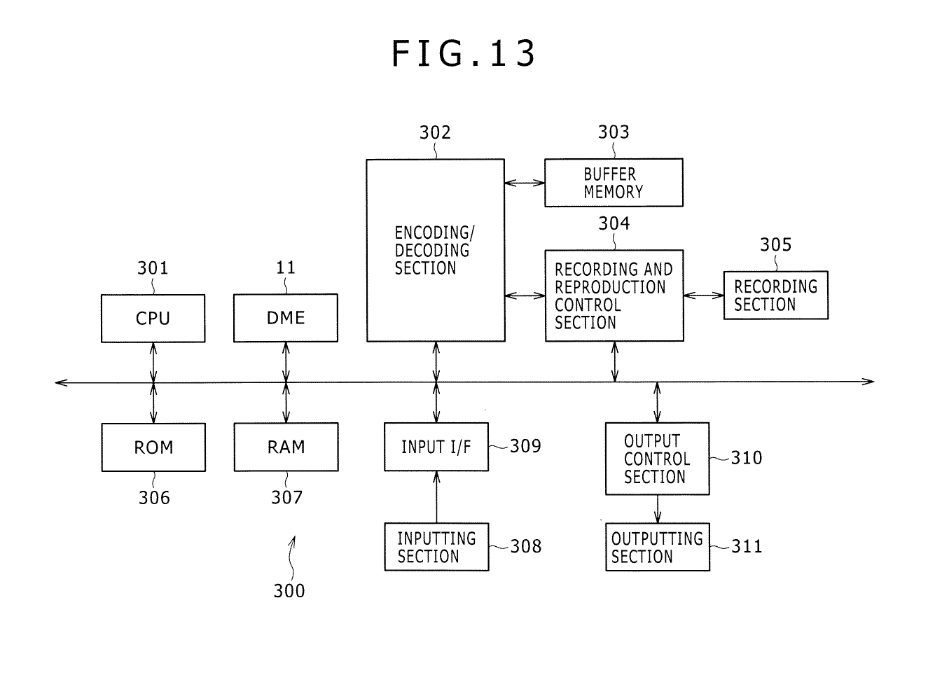

Now, an example of a recording and reproduction apparatus 300 in which the DME 11 is incorporated is described with reference to FIG. 13.

The recording and reproduction apparatus 300 includes a CPU 301 and a DME 11 which execute various processes in accordance with a program stored in a ROM 306 or recorded on a recording section 305. A program to be executed by the CPU 301, data and so forth are stored suitably into a RAM 307. The DME 11, CPU 301, ROM 306 and RAM 307 are connected to each other by a bus.

Also an input I/F (interface) 309 and the CPU 301 are connected to the CPU 301 through the bus. An inputting section 308 is connected to the input I/F 309 and includes a keyboard, a mouse, a microphone, a reception section for receiving an instruction transmitted from a remote controller not shown and so forth, an image pickup section for picking up an image of an object and so forth. Meanwhile, an outputting section 311 is connected to the CPU 301 and includes a display unit, a speaker and so forth. The CPU 301 executes various processes in response to an instruction inputted thereto from the inputting section 308 through the input I/F 309. The CPU 301 outputs results of the processes to the outputting section 311 through the CPU 301.

For example, the CPU 301 controls the DME 11 in response to an instruction inputted thereto from the inputting section 308 to perform reduction, enlargement, change of the type, rotation, leftward and rightward reversal, inversion or movement of an input image or apply a special effect to an input image. Further, the CPU 301 controls the outputting section 311 to display, based on an image outputted from the DME 11, the display through an output control section 310.

Further, an encoding/decoding circuit 302 and a recording and reproduction control section 304 are connected to the CPU 301 through the bus. The encoding/decoding circuit 302 retains an image obtained, for example, as a result of image pickup by the inputting section 308 into a buffer memory 303 as occasion demands and encodes the image in accordance with a predetermined encoding system such as the JPEG (Joint Photographic Experts Group) or MPEG (Moving Picture Experts Group) system under the control of the CPU 301. Then, the encoding/decoding circuit 302 records an image obtained as a result of the encoding into the recording section 305 through the recording and reproduction control section 304.

The recording and reproduction control section 304 controls recording and reproduction of the recording section 305 under the control of the CPU 301. In particular, the recording and reproduction control section 304 controls the recording section 305 to record an image supplied from the encoding/decoding circuit 302 or supplies an image reproduced from the recording section 305 to the encoding/decoding circuit 302. The encoding/decoding circuit 302 decodes the image from the recording and reproduction control section 304 and supplies an image obtained as a result of the decoding, for example, as an input image to the DME 11 under the control of the CPU 301.

While, in the embodiment described above, the pixel value group 101 is composed of 64 pixel values, the number of pixel values which compose the pixel value group 101 is not limited to this.

The present invention can be applied, for example, to a GPU (Graphics Processing Unit).

It is to be noted that, in the present specification, the steps which describe the program recorded in a program recording medium may be but need not necessarily be processed in a time series in the order as described, and include processes which are executed in parallel or individually without being processed in a time series.

Further, in the present specification, the term “system” is used to represent an entire apparatus composed of a plurality of devices or apparatus.

While a preferred embodiment of the present invention has been described using specific terms, such description is for illustrative purpose only, and it is to be understood that changes and variations may be made without departing from the spirit or scope of the following claims.

What is claimed is:

1. An image processing apparatus for interpolating a pixel value of an interpolation pixel which makes an object of an interpolation process, comprising:
production means configured to produce, based on the position of the interpolation pixel, a pixel value group including the pixel value of the interpolation pixel and a plurality of pixel values of different pixels to be used for the interpolation process;
write control means configured to control a plurality of storage means for storing pixel values so that the pixel values of the pixels included in the pixel value group produced by said production means are written into different ones of said storage means;
readout control means configured to control said storage means so that the pixel values of the pixels included in the pixel value group are read out at a time from said storage means in which the pixel values of the pixels included in the pixel value group are stored; and
interpolation means configured to interpolate the pixel value of the interpolation pixel using the pixel value group read out by said readout control means.

2. The image processing apparatus according to claim 1, further comprising:
rearrangement means configured to rearrange the pixel values of the pixel value group read out by said read control means so as to be in an order corresponding to the interpolation process of said interpolation means, said interpolation means performing the interpolation process for the pixel value of the interpolation pixel using the pixel value group rearranged by said rearrangement means.

3. An image processing method for interpolating a pixel value of an interpolation pixel which makes an object of an interpolation process, comprising the steps of:
producing, based on the position of the interpolation pixel, a pixel value group including the pixel value of the interpolation pixel and a plurality of pixel values of different pixels to be used for the interpolation process;
controlling a plurality of storage means for storing pixel values so that the pixel values of the pixels included in the pixel value group produced by the production step are written into different ones of said storage means;
controlling said storage means so that the pixel values of the pixels included in the pixel value group are read out at a time from said storage means in which the pixel values of the pixels included in the pixel value group are stored; and
interpolating the pixel value of the interpolation pixel using the pixel value group read out by the readout control step.

4. An image processing apparatus for interpolating a pixel value of an interpolation pixel which makes an object of an interpolation process, comprising:
a production section configured to produce, based on the position of the interpolation pixel, a pixel value group including the pixel value of the interpolation pixel and a plurality of pixel values of different pixels to be used for the interpolation process;
a write control section configured to control a plurality of storage sections for storing pixel values so that the pixel values of the pixels included in the pixel value group produced by said production section are written into different ones of said storage sections;
a readout control section configured to control said storage sections so that the pixel values of the pixels included in the pixel value group are read out at a time from said storage sections in which the pixel values of the pixels included in the pixel value group are stored; and
an interpolation section configured to interpolate the pixel value of the interpolation pixel using the pixel value group read out by said readout control section.
